(19) United States
(12) Patent Application Publication
(10) Pub. No.: US 2025/0170721 A1
(43) Pub. Date: May 29, 2025

(54) INFORMATION PROCESSING APPARATUS, INFORMATION PROCESSING METHOD, ROBOT SYSTEM, METOD FOR CONTROLLING ROBOT SYSTEM, METHOD FOR MANUFACTURING ARTICLE, AND RECORDING MEDIUM

(71) Applicant: CANON KABUSHIKI KAISHA, Tokyo (JP)

(72) Inventor: AKIHIRO MURAYAMA, Kanagawa (JP)

(21) Appl. No.: 18/957,491

(22) Filed: Nov. 22, 2024

(30) Foreign Application Priority Data
Nov. 27, 2023 (JP) 2023-200229

(51) Int. Cl. B25J 9/16; B25J 19/02

(52) U.S. Cl. CPC B25J 9/1697; B25J 9/1602; B25J 9/1653; B25J 19/023

(57) ABSTRACT

An information processing apparatus includes a processor configured to acquire a plurality of pieces of image data obtained by imaging an object by changing at least one of a relative positional relationship between the object and an imaging unit and an imaging condition of the imaging unit for setting brightness of an image to be acquired, acquire a region where a point group can be generated from each of the plurality of pieces of image data, and set the imaging condition in a case where the object is imaged by the imaging unit on a basis of the regions acquired.

### BACKGROUND

### Field

The present disclosure is related to an information processing apparatus, an information processing method, a robot system, a method for controlling a robot system, a method for manufacturing an article, and a recording medium.

### Description of the Related Art

An imaging unit such as a stereo camera images an object (workpiece), measures a three-dimensional shape (height information of the workpiece) of the object, and calculates a position and a posture of the object (see Japanese Patent Application Laid-Open No. 2019-27947). When an image of an object is captured in this manner, if the exposure time of the image sensor is not appropriate, the luminance value in the acquired image data is saturated (that is, whiteout) or the contrast is small. Then, when the point group indicating the object is generated (extracted) from the image data, the point group cannot be generated with high accuracy, that is, the position and posture of the object cannot be measured with high accuracy. For this reason, Japanese Patent Application Laid-Open No. 2019-27947 proposes that an object is imaged while the exposure time is changed stepwise, an exposure time in which the number of effective pixels satisfies a predetermined condition is determined, and the determined exposure time is set to a setting value.

### SUMMARY

According to a first aspect of the present disclosure, an information processing apparatus includes a processor configured to acquire a plurality of pieces of image data obtained by imaging an object by changing at least one of a relative positional relationship between the object and an imaging unit and an imaging condition of the imaging unit for setting brightness of an image to be acquired, acquire a region where a point group can be generated from each of the plurality of pieces of image data, and set the imaging condition in a case where the object is imaged by the imaging unit on a basis of the regions acquired.

According to a second aspect of the present disclosure, an information processing apparatus includes a processor configured to acquire a plurality of pieces of image data obtained by imaging an object by changing at least one of a relative positional relationship between the object and an imaging unit and an imaging condition of the imaging unit for setting brightness of an image to be acquired, generate a point group from each of the plurality of pieces of image data, calculate, for each of the point groups generated, a ratio of a number of points to a point group to be generated in a case where the object is imaged by the imaging unit in the same relationship as the positional relationship, and set the imaging condition in a case where the object is imaged by the imaging unit on a basis of the ratios calculated.

According to a third aspect of the present disclosure, an information processing method for processing information by a processor, the method includes acquiring, by the processor, a plurality of pieces of image data obtained by imaging an object by changing at least one of a relative positional relationship between the object and an imaging unit and an imaging condition of the imaging unit for setting brightness of an image to be acquired, calculating, by the processor, a region where a point group can be generated from each of the plurality of pieces of image data, and setting, by the processor, the imaging condition in a case where the object is imaged by the imaging unit on a basis of the regions calculated.

According to a fourth aspect of the present disclosure, an information processing method for processing information by a processor, the method includes acquiring, by the processor, a plurality of pieces of image data obtained by imaging an object by changing at least one of a relative positional relationship between the object and an imaging unit and an imaging condition of the imaging unit for setting brightness of an image to be acquired, generating, by the processor, a point group from each of the plurality of pieces of image data, and calculating, for the generated point group, a ratio of a number of points to a point group to be generated in a case where the object is imaged by the imaging unit in the same relationship as the positional relationship, and setting, by the processor, the imaging condition in a case where the object is imaged by the imaging unit on a basis of the ratios calculated.

Further features of the present disclosure will become apparent from the following description of exemplary embodiments with reference to the attached drawings.

### BRIEF DESCRIPTION OF THE DRAWINGS

FIG. 1 is a schematic view of a robot system according to a first embodiment.

FIG. 2 is a block diagram of the robot system according to the first embodiment.

FIG. 3 is a block diagram of an image processing controller according to the first embodiment.

FIG. 4 is a flowchart of operation processing in an operation mode according to the first embodiment.

FIG. 5 is a schematic view for explaining the operation of the robot system in a setting mode according to the first embodiment.

FIG. 6 is an explanatory diagram illustrating an example of a start screen of the setting mode according to the first embodiment.

FIG. 7 is a flowchart illustrating exposure time setting control in the setting mode according to the first embodiment.

FIG. 8 is a diagram illustrating a relationship between the number of pixels at each angle measured by the measurement of the number of effective pixels according to the first embodiment and an exposure time.

FIG. 9 is an explanatory diagram illustrating an example of a display image of an exposure time adjustment result screen in the setting mode according to the first embodiment.

FIG. 10 is a flowchart illustrating exposure time setting control in a setting mode according to a second embodiment.

FIG. 11A is a diagram illustrating a case where a single exposure time is selected in the relationship between a point group acquisition rate of each angle measured by the measurement of a point group acquisition rate according to the second embodiment and an exposure time.

FIG. 11B is a diagram illustrating a case where a plurality of exposure times are selected in the relationship between the point group acquisition rate of each angle measured by the measurement of the point group acquisition rate according to the second embodiment and an exposure time.

FIG. 12 is an explanatory diagram illustrating a relationship among a virtual camera, a virtual workpiece model, and a virtual point group on a virtual space according to the second embodiment.

FIG. 13 is an explanatory diagram illustrating an example of a display image of an exposure time adjustment result screen in the setting mode according to the second embodiment.

### DESCRIPTION OF THE EMBODIMENTS

When the posture (angle) of the object changes with respect to the imaging direction of an imaging unit, there is a problem that the amount of reflected light reflecting the illumination by the surface of the object changes. For this reason, even if the exposure time is set as in the case of Japanese Patent Application Laid-Open No. 2019-27947, the exposure time is not necessarily appropriate for an object having a different posture from that when the exposure time is set, that is, there is a possibility that the point group cannot be accurately extracted.

Therefore, the present embodiment provides an information processing apparatus, an information processing method, a robot system, a method for controlling a robot system, a method for manufacturing an article, and a recording medium capable of accurately generating a point group.

### First Embodiment

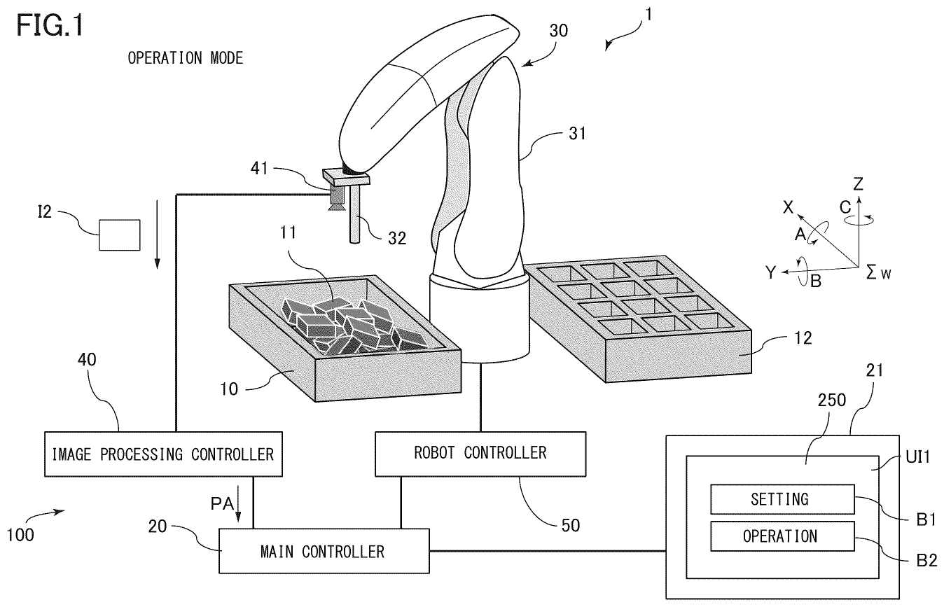

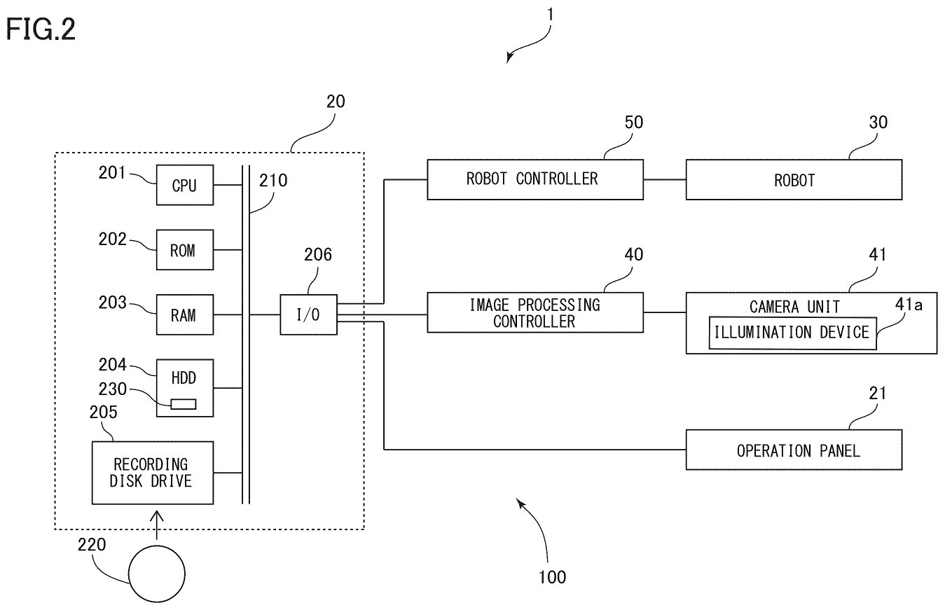

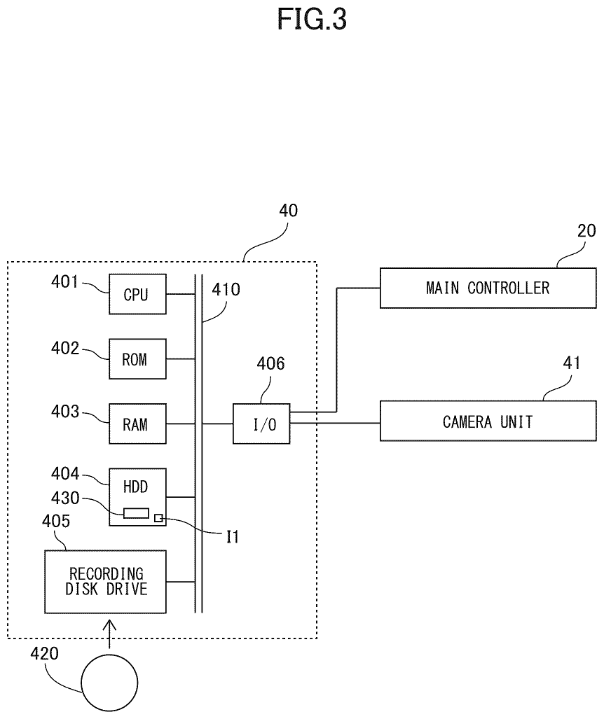

Hereinafter, a first embodiment for carrying out the present disclosure will be described with reference to FIGS. 1 to 9. First, a configuration of a robot system 1 according to the first embodiment will be described with reference to FIGS. 1 to 3. FIG. 1 is a schematic view of the robot system according to the first embodiment. FIG. 2 is a block diagram of the robot system according to the first embodiment. FIG. 3 is a block diagram of the image processing controller according to the first embodiment.

### Schematic Configuration of Robot System

The robot system 1 includes a robot 30, a camera unit 41 which is an example of an imaging unit, an operation panel 21 which is an example of a display unit, a main controller 20, an image processing controller 40, and a robot controller 50.

The robot 30 is a manipulator. The robot 30 of the present embodiment is an industrial robot, and can be used to hold (grip) an object. The robot 30 is provided in a manufacturing line and used in manufacturing of an article. The camera unit 41 is attached to the robot 30. A picking box 10 and a placing box 12 are arranged around the robot 30.

The robot system 1 of the present embodiment is a picking device that takes out the plurality of parts 11 contained in the picking box 10 one by one and transfers the part to the placing box 12. That is, in the present embodiment, the robot 30 is caused to hold the part 11 in the picking box 10, and the robot 30 is caused to perform the conveyance work of conveying the part 11 to the placing box 12 by operating the robot 30. The part 11 is an example of an object. Note that a plurality of picking boxes 10 may be prepared for each type of the parts 11. At that time, the plurality of picking boxes 10 may be sequentially replaced by a conveyor, an AGV, or the like. The placing box 12 has a partition plate provided inside, and is configured to be able to change a position where the part 11 is placed for each type of the part 11. As a result, the placing box 12 can be used to collect parts necessary for assembling a product.

The work of manufacturing the article is not limited to the conveyance work, and may be, for example, an assembling work of assembling a first workpiece held by the robot 30 to a second workpiece, a machining work, or a coating work. The machining work may be, for example, a cutting work, a grinding work, a polishing work, or a sealing work.

The robot 30 includes a robot arm 31 and a holding unit 32 which is an example of an end effector and serves as a holding portion. An end effector corresponding to work is attached to the robot arm 31, and the holding unit 32 is attached in the example of the present embodiment.

In the present embodiment, the robot arm 31 is a vertically articulated robot arm. A base end (fixed end) of the robot arm 31 is installed on a pedestal (not illustrated). The holding unit 32 and the camera unit 41 are attached to a leading edge (free end) which is a predetermined portion of the robot arm 31. The robot arm 31 can adjust the holding unit 32, the object held by the holding unit 32, and the camera unit 41 to arbitrary positions (including postures) in the world coordinate system >w.

As described above, the holding unit 32, the object held by the holding unit 32, and the camera unit 41 can move in six degrees of freedom in the world coordinate system >w. That is, the holding unit 32, the object held by the holding unit 32, and the camera unit 41 can move in three degrees of freedom on straight lines of the X axis, the Y axis, and the Z axis in the world coordinate system, and can move in three degrees of freedom in rotation of the A axis about the X axis, the B axis about the Y axis, and the C axis about the Z axis. The X axis, the Y axis, and the Z axis are axes orthogonal to each other.

The camera unit 41 is, for example, a unit of a stereo camera in which two digital cameras are arranged at a known distance, and each digital camera has a lens (not illustrated), an image sensor (not illustrated), and the like. The image sensor is, for example, a CMOS image sensor or a CCD image sensor. Furthermore, the camera unit 41 includes an illumination device 41a (see FIG. 2), and the illumination of the illumination device 41a is preferably capable of projecting pattern light so that a three-dimensional point group can be easily generated even for a workpiece having few irregularities on the surface or a workpiece having no texture. Examples of the pattern light include a random dot pattern and a space code pattern.

The camera unit 41 is configured to capture an image of an object existing in a visual field, that is, an imaging region, according to setting information in which imaging conditions are set, and transmit image data obtained by the imaging, that is, captured image data to the image processing controller 40. Note that the imaging condition mentioned here is a condition for setting brightness of the captured image data. In the present embodiment, the brightness and the diaphragm value of the illumination are constant, and the exposure time is used as a variation parameter of the imaging condition, that is, only the exposure time is variably set. However, as long as the brightness in the image data can be changed, the brightness of the illumination, the shutter speed (for example, the speed of the imaging element shutter), and the diaphragm value if the lens has a diaphragm function may be set as the variation parameters of the imaging condition.

The main controller 20 is a device that integrally controls the entire robot system 1. The image processing controller 40, the robot controller 50, and the operation panel 21 are connected to the main controller 20.

The operation panel 21 includes a touch panel display 250, and functions as a display unit capable of displaying an image and an input unit capable of inputting various types of information by being operated by the user. In the present embodiment, the operation panel 21 displays a user interface (UI) image UI1 as a graphical user interface (GUI) on the touch panel display 250 in accordance with a command from the main controller 20. That is, the main controller 20 receives an input operation from the user via the UI image UI1 displayed on the operation panel 21. The operation panel 21 includes the touch panel display 250 in which the display unit and the input unit are integrated, but is not limited thereto. For example, the display unit and the input unit may be configured separately. Furthermore, in the present embodiment, the touch panel display 250 of the operation panel 21 has been described as an example, but may be an external computer connected via a network or the like, for example. In this case, a monitor connected to the external computer is configured as a display unit, and a mouse, a keyboard, or the like is configured as an input unit.

The holding unit 32 is a holding mechanism capable of holding the part 11, and for example, a suction type hand, a vacuum suction type hand, a holding type hand having fingers, or the like can be applied.

The robot controller 50 can control the operation of the robot 30, that is, the operations of the robot arm 31 and the holding unit 32 according to a command of the main controller 20. As a result, the position and posture of the holding unit 32 can be freely controlled, and the part 11 can be freely held (picked). Furthermore, the position and posture of the camera unit 41 can be freely controlled by controlling the operation of the robot arm 31. That is, the posture of the camera unit 41 can be controlled, and the imaging direction (imaging angle AG) with respect to the workpiece can be controlled. In short, the imaging angle AG as a relative positional relationship between the camera unit 41 and the workpiece can be controlled.

The image processing controller 40 can control the camera unit 41 according to a command of the main controller 20, and can perform image processing on image data obtained from the camera unit 41. Examples of the image processing include two-dimensional image data processing, three-dimensional point group generation, recognition of a position and a posture of the part 11 by matching processing, interference determination between the part 11 and the holding unit 32 based on the acquired point group, and the like.

The matching processing is processing of detecting the position and posture of the part 11 by matching image data (captured image data) as first image data I1 obtained by imaging the part 11 with reference image data. Specifically, the reference image data is, for example, image data of a three-dimensional model created based on three-dimensional CAD data. The position and posture of the part 11 can be calculated by performing matching processing between the point group generated from the image data of the model and the point group generated from the part 11 of the captured image data. Schematic configuration of each controller

Next, a schematic configuration of each controller will be described. As illustrated in FIG. 2, the main controller 20 includes a computer. The main controller 20 includes a central processing unit (CPU) 201 as a processor.

In addition, the main controller 20 includes a read only memory (ROM) 202, a random access memory (RAM) 203, and a hard disk drive (HDD) 204 as an example of the storage unit. In addition, the main controller 20 includes a recording disk drive 205 and an input/output interface (I/O) 206. The ROM 202, the RAM 203, the HDD 204, the recording disk drive 205, and the I/O 206 are connected to the CPU 201 via a bus 210.

The ROM 202 stores a basic program such as BIOS. The RAM 203 is a storage device that temporarily stores various data such as an arithmetic processing result of the CPU 201.

The HDD 204 is a storage device that stores an arithmetic processing result of the CPU 201, various data acquired from the outside, and the like. A program 230 for causing the CPU 201 to execute arithmetic processing is recorded in the HDD 204. The program 230 is application software. The CPU 201 executes each processing of a part of an information processing method to be described later, that is, a part of an image processing method, on the basis of the program 230 recorded (stored) in the HDD 204. The recording disk drive 205 can read various data, programs, and the like recorded in a recording disk 220.

The robot controller 50, the image processing controller 40, and the operation panel 21 are connected to the I/O 206. The CPU 201 sends commands to the robot controller 50, the image processing controller 40, and the operation panel 21 via the I/O 206. In addition, the CPU 201 acquires information from each of the robot controller 50, the image processing controller 40, and the operation panel 21 via the I/O 206. Note that a storage device such as a rewritable nonvolatile memory or an external HDD may be connectable to the I/O 206. In addition, a network may be connectable to the I/O 206.

The HDD 204 is also a non-transitory computer-readable recording medium. In the present embodiment, the program 230 is stored in the HDD 204, but the present technology is not limited thereto. The program 230 may be recorded in any recording medium as long as the recording medium is a non-transitory computer-readable recording medium. For example, a flexible disk, a hard disk, an optical disk, a magneto-optical disk, a magnetic tape, or a nonvolatile memory can be used as the recording medium for supplying the program 230. The optical disk is, for example, a disk medium such as a Blu-ray disk, a DVD, or a CD. The nonvolatile memory is, for example, a storage device such as a USB memory, a memory card, a ROM, or an SSD. In addition, the program 230 may be downloaded from a network.

As illustrated in FIG. 3, the image processing controller 40 includes a computer. The image processing controller 40 includes a CPU 401 as a processor.

In addition, the image processing controller 40 includes a ROM 402, a RAM 403, and an HDD 404 as an example of a storage unit. The image processing controller 40 also includes a recording disk drive 405 and an input/output interface (I/O) 406. The ROM 402, the RAM 403, the HDD 404, the recording disk drive 405, and the I/O 406 are connected to the CPU 401 via a bus 410.

The ROM 402 stores a basic program such as a BIOS. The RAM 403 is a storage device that temporarily stores various data such as an arithmetic processing result of the CPU 401.

The HDD 404 is a storage device that stores an arithmetic processing result of the CPU 401, various data acquired from the outside, and the like. A program 430 for causing the CPU 401 to execute arithmetic processing is recorded in the HDD 404. The program 430 is application software. The CPU 401 executes each processing of a part of an information processing method to be described later, that is, a part of an image processing method, on the basis of the program 430 recorded (stored) in the HDD 404. The recording disk drive 405 can read various data, programs, and the like recorded in a recording disk 420.

The main controller 20 and the camera unit 41 are connected to the I/O 406. The CPU 401 receives a command from the main controller 20 via the I/O 406. Then, the CPU 401 controls the camera unit 41 according to the command. In addition, the CPU 401 acquires captured image data from the camera unit 41 via the I/O 406. Then, the CPU 401 executes image processing and sends information indicating a result of the image processing to the main controller 20. Note that a storage device such as a rewritable nonvolatile memory or an external HDD may be connectable to the I/O 406. In addition, a network may be connectable to the I/O 406.

The HDD 404 is also a non-transitory computer-readable recording medium. In the present embodiment, the program 430 is stored in the HDD 404, but the present technology is not limited thereto. The program 430 may be recorded in any recording medium as long as the recording medium is a non-transitory computer-readable recording medium. For example, a flexible disk, a hard disk, an optical disk, a magneto-optical disk, a magnetic tape, or a nonvolatile memory can be used as the recording medium for supplying the program 430. The optical disk is, for example, a disk medium such as a Blu-ray disk, a DVD, or a CD. The nonvolatile memory is, for example, a storage device such as a USB memory, a memory card, a ROM, or an SSD. In addition, the program 430 may be downloaded from a network.

Although the configurations of the main controller 20 and the image processing controller 40 have been described in detail above, the robot controller 50 is also configured by a similar computer, and thus a detailed description thereof will be omitted. That is, the robot controller 50 also includes a processor such as a CPU and a storage device such as an HDD. Then, the processor of the robot controller 50 operates on the basis of the program to control the robot 30.

In the present embodiment, the robot system 1 includes a control system 100 that functions as an information processing apparatus (that is, an image processing apparatus). The control system 100 includes the main controller 20, the image processing controller 40, and the robot controller 50. That is, the control system 100 includes a plurality of computers. Therefore, in the present embodiment, the CPU 201 executes the program 230, and the CPU 401 executes the program 430, whereby the CPU 201 and the CPU 401 function as processors.

Although the main controller 20 and the image processing controller 40 are configured by separate computers, the present technology is not limited thereto, and the main controller 20 and the image processing controller 40 may be configured by one computer. In addition, the main controller 20, the image processing controller 40, and the robot controller 50 may be configured by one computer.

That is, the control system 100 may include one or a plurality of computers. In the example of the present embodiment, the control system 100 includes three computers. Furthermore, one, two, or all of the three computers may be external computers connected via a network or the like. That is, the control system as the information processing apparatus may be configured by an external computer.

Here, as illustrated in FIG. 1, the UI image UI1 is displayed on the touch panel display 250 according to a command from the main controller 20. The CPU 201 of the main controller 20 is configured to be able to selectively execute a first mode and a second mode. The first mode is a setting mode in which the exposure time is determined and set by the image processing controller 40. The second mode is an operation mode in which the part 11 is imaged by the camera unit 41 at the exposure time set, the image processing controller 40 is caused to execute image processing, and the robot 30 is caused to perform a picking work of picking the part 11 on the basis of the result of the image processing. The setting mode is performed at the time of installation or startup of the robot system 1.

As illustrated in FIG. 1, the UI image UI1 includes a button B1 for causing the main controller 20 to execute the setting mode and a button B2 for causing the main controller 20 to execute the operation mode. When the button B1 is operated by the user, the CPU 201 of the main controller 20 executes the setting mode, and when the button B2 is operated by the user, the CPU 201 of the main controller 20 executes the operation mode. As a result, the user can select which mode is to be executed by the control system 100 (main controller 20) by operating the UI image UI1.

### Operation Process in Operation Mode

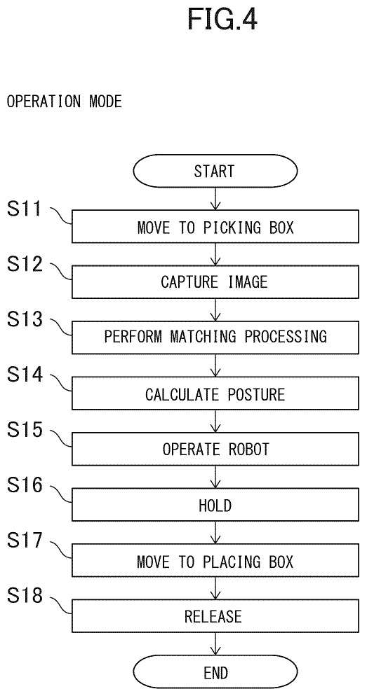

Next, a case where the operation mode is selected by the user will be described. For example, when the button B2 in FIG. 1 is operated, the CPU 201 and the CPU 401 execute processing corresponding to the operation mode. FIG. 4 is a flowchart of operation processing in the operation mode according to the first embodiment.

In step S11, the CPU 201 of the main controller 20 transmits a command to the robot controller 50 to operate the robot 30, and moves the camera unit 41 attached to the robot 30 to the upper side of the picking box 10.

Note that the CPU 201 of the main controller 20 preferably takes in information of the posture of the robot 30 before the operation of the robot 30, and operates the robot 30 by providing a via-point according to the situation so as not to interfere with the placing box 12 and the picking box 10.

Next, in step S12, the CPU 401 of the image processing controller 40 causes the camera unit 41 to capture an image of the part 11 in the picking box 10 (imaging process). Second image data I2 generated by the camera unit 41 is transferred to the image processing controller 40 via wiring as illustrated in FIG. 1. The captured image data acquired in step S12 is set as the second image data I2 to be distinguished from the captured image data (first image data I1) acquired in step S23 described later.

Note that the camera unit 41 turns on the illumination device 41a before imaging, and turns off the illumination device 41a after imaging is completed. Here, the exposure time when the camera unit 41 captures an image is an exposure time T2 set in the exposure time setting control described later in detail. In short, the CPU 401 of the image processing controller 40 controls the camera unit 41 on the basis of the exposure time T2 to perform the imaging.

Next, in step S13, the CPU 401 of the image processing controller 40 performs matching processing with the model image on the second image data I2 obtained by the imaging in step S12. As a result, the information of the position (including the posture) of the part 11 is detected, and the information of a detected position PA is output to the main controller 20.

In a case where there are a plurality of parts 11 in the picking box 10, information of a plurality of detected positions and a degree of coincidence corresponding to the information of each detected position are obtained from the captured image data by matching processing. Therefore, the CPU 401 of the image processing controller 40 preferably sorts the parts in descending order of the degree of coincidence and outputs the information of the detected position of the part 11.

Next, in step S14, the CPU 201 of the main controller 20 calculates the posture of the robot 30 for causing the holding unit 32 to face the part 11 to be taken out on the basis of the information of the detected position PA of the part 11 acquired from the CPU 401. Note that the positional relationship between the camera unit 41 and the holding unit 32 in the flange coordinate system is obtained in advance by calibration or the like. Note that, in a case where there are a plurality of parts 11 in the picking box 10, in order to acquire information of a plurality of detected positions, it is preferable that the CPU 201 prioritizes the parts so as not to interfere with the picking box 10, the surrounding parts 11, and the like, and selects the part 11 to be taken out.

Next, in step S15, the CPU 201 of the main controller 20 sends a command to the robot controller 50, operates the robot 30 in the posture calculated in step S14, and moves the holding unit 32 to a position where the holding unit 32 can hold the part 11. At that time, it is preferable to appropriately provide a via-point so as not to interfere with the picking box 10 and the surrounding parts 11 to operate the robot 30.

Next, in step S16, the CPU 201 of the main controller 20 sends a command to the robot controller 50 to cause the holding unit 32 to hold (pick) the part 11.

Next, in step S17, the CPU 201 of the main controller 20 sends a command to the robot controller 50 to operate the robot 30 to move the part 11 to the placing box 12. In a case where there is a partition in the placing box 12, the position where the part 11 is placed may be changed according to the type of the part 11, the number of times of taking out, and the like. When the part 11 is moved, it is preferable to appropriately provide a via-point so that the robot 30 and the part 11 do not interfere with the picking box 10 and the placing box 12.

Next, in step S18, the CPU 201 of the main controller 20 sends a command to the robot controller 50, causes the holding unit 32 to release the part 11, and places the part 11 in the placing box 12. As described above, the operation of picking one part 11 from the picking box 10 and placing the part in the placing box 12 is completed. Subsequently, in a case where work on the next part 11 is required, this operation mode is repeatedly executed as many times as the required number of parts 11.

### Outline of Setting Mode

Next, a setting mode for setting the exposure time T2 when imaging is performed by the camera unit 41 in step S12 of the operation mode will be described.

For example, in a case where the part 11 is imaged and the matching processing is executed, the point group is generated from the imaged image data and the matching is performed. The point group generated at this time is affected in generation accuracy by brightness (contrast) of the captured image data. That is, when the image of the part 11 in the image data is too bright, the luminance value is saturated, the point group cannot be correctly acquired, and missing occurs. In addition, even if the image of the part 11 in the image data is too dark, the contrast is small, the point group cannot be correctly acquired, and missing occurs. In particular, as described above, in a case where the surface of the part 11 is irradiated with pattern light from the illumination of the camera unit 41, it is assumed that the posture of the part 11 is such that the camera is positioned in a direction greatly different from the specular reflection direction with respect to the incident light from the illumination. At this time, if the exposure time is short, there is a problem that imaging is performed in a state where the contrast of the pattern light from the illumination is small, and the point group cannot be correctly acquired and is lost.

In a case where the part 11 is picked by the robot system 1 as described above, the position and the posture of the part 11 are detected by the matching processing of the part 11 from the image data as the second image data I2 captured by the camera unit 41. The exposure time in the case of imaging by the camera unit 41 at this time is set hitherto as follows. That is, samples obtained by manually stacking the parts 11 in a bulk work in advance are imaged while changing the exposure time by the camera unit 41, and the exposure time with which a point group can be generated with high accuracy (matching processing becomes high accuracy) is selected and set.

However, in this sample, for example, when the part 11 having a large angle at which the surface (specular reflection direction) faces the camera unit 41 is not stacked, the exposure time is set short because the reflected light becomes bright. Then, in an actual picking operation, in a case where the parts 11 whose surfaces face at a large angle with respect to the camera unit 41 are mixed, the matching processing does not work well, and there is a possibility that picking cannot be performed or interference of the holding unit 32 is caused. Therefore, variations in the setting of the exposure time also occur due to variations in the samples created in the bulk stacking work.

In order to solve the above problem, it is desired to develop a device capable of accurately generating a point group regardless of the posture of the part 11 with respect to the camera unit 41, and the problem is solved by exposure time setting control according to the present embodiment described later in detail.

### Operation Processing in Setting Mode

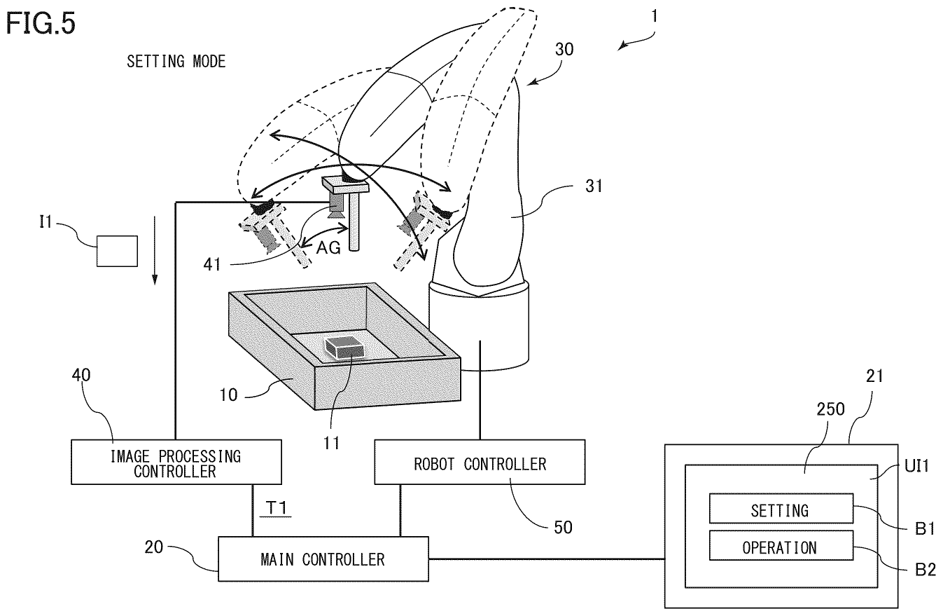

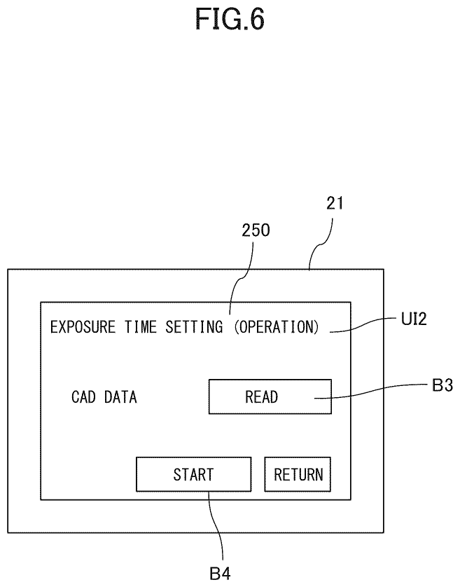

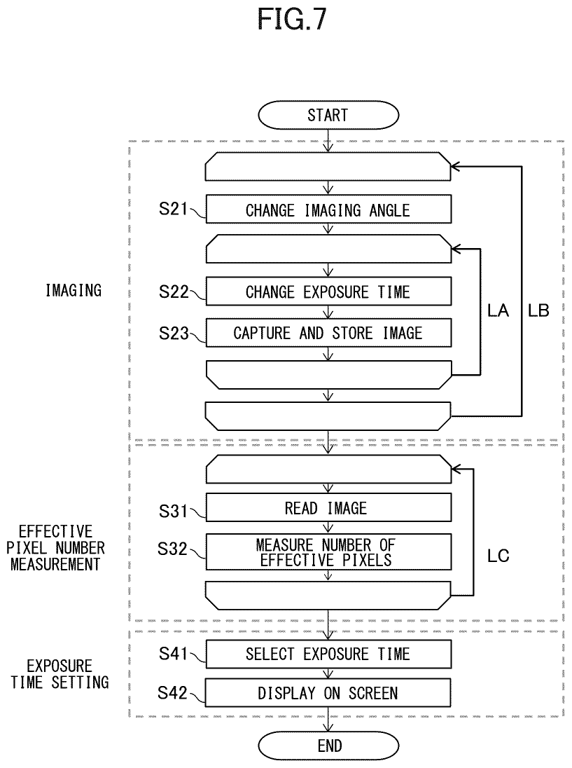

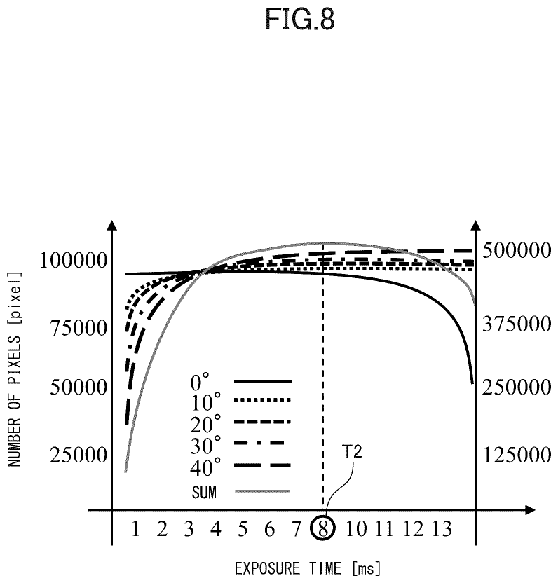

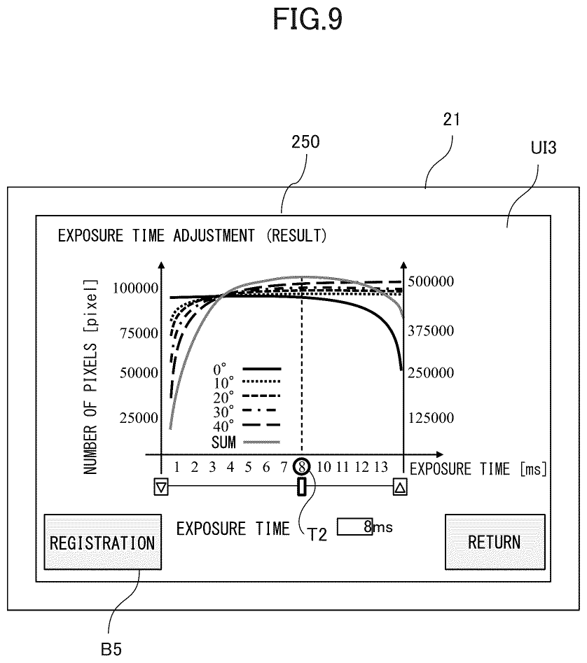

Next, a case where the setting mode (execution of exposure time setting control) is selected by the user will be described with reference to FIGS. 5 to 9. FIG. 5 is a schematic view for explaining the operation of the robot system in the setting mode according to the first embodiment. FIG. 6 is an explanatory diagram illustrating an example of a start screen of the setting mode according to the first embodiment. FIG. 7 is a flowchart illustrating exposure time setting control in the setting mode according to the first embodiment. FIG. 8 is a diagram illustrating a relationship between the number of pixels at each angle measured by the measurement of the number of effective pixels according to the first embodiment and the exposure time. FIG. 9 is an explanatory diagram illustrating an example of a display image of an exposure time adjustment result screen in the setting mode according to the first embodiment.

### Preparation of Operation in Setting Mode

First, before the setting mode is executed, as illustrated in FIG. 5, only one part 11 is placed at the center of the picking box 10 in advance. At this time, the relative positional relationship (imaging direction (imaging angle AG)) between the part 11 and the camera unit 41 is set to a positional relationship in which the imaging direction (imaging angle AG) of the camera unit 41 is oriented in the specular reflection direction with respect to the incident light from the illumination.

Subsequently, when the button B1 of the UI image UI1 illustrated in FIG. 5 is operated, the CPU 201 and the CPU 401 execute processing corresponding to the setting mode. First, the CPU 201 switches from the UI image UI1 illustrated in FIG. 5 to a UI image UI2 (start screen of the setting mode) illustrated in FIG. 6 and displays the UI image UI2 on the operation panel 21.

Meanwhile, the CPU 201 causes the CPU 401 of the image processing controller 40 to read CAD data. The CAD data is data necessary for obtaining the contour of the part 11 when the matching processing is performed, and is stored in a storage device inside or outside the image processing controller 40, for example, the HDD 404. The user selects CAD data of the part 11 in a file format with a dialog box or the like, and operates a read button B3 in FIG. 6 to cause the CPU 401 of the image processing controller 40 to read the CAD data. The CAD data read by the CPU 401 is temporarily stored in the RAM 403. When the user operates a start button B4 after the CPU 201 causes the CPU 401 to read the CAD data by the user's operation, the CPU 201 and the CPU 401 execute the following exposure time setting processing.

### Exposure Time Setting Control According to First Embodiment

Next, exposure time setting control as a first setting process according to the first embodiment will be described. As illustrated in FIG. 7, the exposure time setting control according to the first embodiment is roughly divided into imaging processing, effective pixel number measurement processing, and exposure time setting processing, and is executed in this order. The imaging processing is an image acquisition process of acquiring the plurality of pieces of first image data I1 in the main controller 20. The effective pixel number measurement processing is a region calculation process of calculating the size of the region where the point group can be generated in each piece of the first image data I1 acquired in the image acquisition process. Furthermore, the exposure time setting processing is a setting process of setting an imaging condition (exposure time T2) in a case where the second image data I2 is captured by the camera unit 41 on the basis of the size of the region calculated in the region calculation process.

Note that, in the present embodiment, a description will be given of performing the effective pixel number measurement processing after performing the imaging processing on all the first image data I1. However, the present technology is not limited thereto, and the effective pixel number measurement processing may be performed every time the imaging processing is performed for one image or a predetermined number of images, and then the process may return to the imaging processing for the other images.

First, in step S21, the CPU 201 of the main controller 20 sends a command to the robot controller 50 to operate the robot 30 to incline the camera unit 41 to an arbitrary angle and move the part 11 so as to be positioned at the center of the imaging region.

Step S21 is repeatedly processed by the loop LB, and each time, the camera unit 41 is changed to be inclined to a different angle (imaging angle AG), that is, the imaging angle AG at which the part 11 is imaged is changed. As the direction in which the camera unit 41 is inclined, it is desirable to combine the two directions indicated by the arrows in FIG. 5, that is, to comprehensively image the upper half of the part 11 while moving the camera unit 41 on the hemispherical surface. In one loop LB, the angle at which the camera unit 41 is inclined (the movement angle of one imaging angle AG) may be determined by the user, or the pitch may be made coarse or fine or adjustable in accordance with the shape, material, or color of the part 11. In the present embodiment, an example will be described on the assumption that the movement is, for example, every 10 degrees (see FIG. 8).

Note that, in the present embodiment, the camera unit 41 is moved with respect to the part 11 to change the imaging angle AG, but the present technology is not limited thereto, and any configuration may be used as long as the camera unit 41 and the part 11 can be imaged by relatively changing the imaging angle AG. For example, the posture of the part 11 may be changed by causing the robot 30 to support the part 11 while the camera unit 41 is fixed. Furthermore, for example, the imaging angle AG may be relatively changed by separately providing an actuator to change the posture of the camera unit 41 or the part 11.

Next, in step S22, the CPU 401 of the image processing controller 40 changes an exposure time T1 for imaging by the camera unit 41. This step S22 is repeatedly processed by the loop LB, and is set to a different exposure time T1 each time. The range in which the exposure time T1 is changed preferably includes a range from a short exposure time in which the captured image is crushed in black even when the part 11 is white to a long exposure time in which the captured image is blown out in white even when the part 11 is black. In the present embodiment, for example, a case where changing by 1 ms in the range of 1 ms to 15 ms will be described as an example (see FIG. 8).

Then, in step S23, the CPU 401 of the image processing controller 40 images the part 11 in the picking box 10 by the camera unit 41. That is, the image data in which the part 11 is captured as the first image data I1 is generated by the camera unit 41, transferred to the image processing controller 40 via the wiring, and stored in a storage device of the image processing controller 40, for example, the HDD 404.

In step S23, imaging is executed several hundred times by a double loop of a loop LB for changing the imaging angle AG and a loop LA for changing the exposure time. As a result, the CPU 401 of the image processing controller 40 acquires a plurality of pieces of first image data I1 obtained by the camera unit 41 imaging the same one part 11 at various imaging angles AG and various exposure times T1, and the first image data I1 is accumulated in the HDD 404.

As described above, in steps S21 to S23 of the imaging processing, the CPU 401 causes the camera unit 41 to image the part 11 by making the exposure time T1 and the imaging angle AG of the camera unit 41 different, and acquires the plurality of pieces of first image data I1.

Next, the process proceeds to the effective pixel number measurement processing, and in step S31, the CPU 401 of the image processing controller 40 reads the first image data I1 captured and stored in step S23. Step S31 is repeatedly performed by a loop LC, and the images in which the imaging angle AG and the exposure time T1 are changed are sequentially read each time. This loop LC is performed on all images captured by changing the imaging angle AG and the exposure time T1.

Subsequently, in step S32, the CPU 401 of the image processing controller 40 measures the number of pixels capable of generating a point group for each of the first image data I1 read in step S31. For example, in a case where a random dot pattern is used as the illumination, a portion where the luminance value is not saturated and is not blackened in the first image data I1 is counted as a pixel capable of generating a point group, and the counted total number is calculated as the number of effective pixels. In addition, for example, in a case where the space code pattern is used as the illumination, the pixel in which the contrast of the luminance value of each pixel is equal to or greater than a threshold is counted as the pixel capable of generating the point group, and the counted total number is calculated as the number of effective pixels. Note that which type of pattern illumination is used may be set by the user, and the counting method may be switched according to the setting. In addition, a point group may be actually generated from the first image data I1, and the number of valid point groups may be counted.

By the way, in the present embodiment, measuring the number of pixels has been described, but it is also conceivable that the size per pixel may be different depending on the performance of the image sensor, or the size of the part 11 in one image may be different. Therefore, instead of measuring by the number of pixels, a portion where the point group can be generated may be measured as a region (area). That is, the number of effective pixels can be said to be a size of a region where the point group can be generated. Similarly, even in a case where the point group is actually generated, there is no change in the size of the region where the point group can be generated in the image. Note that, in the present embodiment, imaging is performed by the same camera unit 41 (image sensor), and imaging is performed while moving the camera unit 41 on the hemispherical surface so that the relative distance between the camera unit 41 and the part 11 becomes substantially the same. Therefore, there is no particular problem even if measurement is performed with the number of effective pixels.

Next, the process proceeds to the exposure time setting processing, and in step S41, the CPU 401 of the image processing controller 40 selects (selects and determines, and sets) the exposure time T2 in a case where the camera unit 41 captures the second image data I2 in the above-described operation mode. That is, first, for each exposure time T1 changed in step S22, the sum of the number of effective pixels calculated in step S32 is calculated for a plurality of pieces of first image data I1 each having the imaging angle AG which is changed in step S21 and different from each other. When the sum of the number of effective pixels is calculated in this manner, the exposure time T2 at which the sum becomes maximum is selected and sent to the main controller 20. The CPU 201 of the main controller 20 sets the exposure time T2 as the exposure time at the time of imaging of the camera unit 41 in the operation mode (see S12).

Specifically, as illustrated in FIG. 8, in a case where the imaging angle AG between the part 11 and the camera unit 41 is an angle at which the camera unit 41 comes in the specular reflection direction with respect to the incident light from the illumination (0 degrees), the number of effective pixels where the point group can be generated is large in a range where the exposure time T1 is short. However, when the exposure time T1 becomes long, the number of pixels in which blown-out highlights occur due to specular reflection light from the illumination increases, and the number of effective pixels where the point group can be generated decreases. On the other hand, in a case where the imaging angle AG between the part 11 and the camera unit 41 is an angle at which the camera unit 41 comes in a direction greatly different from the specular reflection direction with respect to the incident light from the illumination (10 degrees to 40 degrees), when the exposure time TI becomes long, the number of effective pixels where the point group can be generated increases. However, as the exposure time T1 decreases, the number of effective pixels where the point group can be generated decreases due to blackening of the pixels or a decrease in contrast of the illumination pattern. Therefore, when the sum of the number of effective pixels, where the point group can be generated, of each imaging angle AG is calculated for each exposure time T1, a peak having the maximum value is formed. The exposure time T1 when the value of the sum reaches a peak, that is, when the number of effective pixels where the point group can be generated reaches a maximum value is set as the exposure time T2 in the operation mode (when picking).

Note that, in the graph illustrated in FIG. 8, a graph in a case where the imaging angle AG is changed by 10 degrees is illustrated, but the imaging angle AG may be changed more finely according to the shape of the part. In addition, in the graph illustrated in FIG. 8, the curve for each imaging angle AG is linearly complemented, but each imaging angle AG and the number of effective pixels may be taken at each exposure time T1, that is, any graph display method may be used. Furthermore, the graph illustrated in FIG. 8 illustrates an example in which the imaging angle AG is changed by rotating around one axis, but it is desirable to select the exposure time T2 from a combination of the imaging angles AG changed by rotating around two axes.

Then, in step S42, as illustrated in FIG. 9, the main controller 20 displays a UI image UI3 indicating the graph of FIG. 8 (the number of effective pixels calculated from the plurality of pieces of first image data I1 having the imaging angles different from each other) and the selected exposure time T2 on the operation panel 21. Here, when a registration button B5 of the UI image UI3 displayed on the operation panel 21 is pressed, the displayed exposure time T2 is overwritten as a setting value of the exposure time T2 in the operation mode. In addition, by displaying a graph of the number of pixels in which the point group can be generated for each exposure time on the UI image UI3, it is possible to confirm that the exposure time T2 can be normally adjusted. Furthermore, when the number of pixels where the point group can be generated is extremely small depending on the imaging angle AG, the user can change the exposure time T2 by manually sliding the exposure time or directly inputting a value.

Note that, as described above, after the exposure time setting control illustrated in FIG. 7 is executed and the setting of the exposure time T2 is completed, the parts 11 may be installed in a bulk state in the picking box 10 and imaged, and it may be confirmed whether the exposure time T2 which is set is appropriate. At this time, for example, a pixel where the point group can be generated from a captured image and a pixel where the point group cannot be generated are displayed on the operation panel 21. As a result, the user can confirm the missing state of the point group. Furthermore, in this case, the part 11 for calculating the pixel capable of generating the point group is selected from the parts 11 on the surface layer in a state of being stacked in bulk by the user. This is because the part 11 under the overlap cannot be distinguished from the missing of the point group due to the exposure time because the point group cannot be acquired due to occlusion. Then, if the user determines that there are lots of missing in the point group, it is conceivable that the exposure time setting control is executed again or the user manually adjusts the exposure time T2. Furthermore, it is also conceivable to perform imaging while changing the exposure time T1 and the imaging angle AG with respect to the parts 11 in the current bulk state, and to re-acquire the plurality of pieces of first image data I1 obtained by imaging the parts 11 in the bulk state. That is, the exposure time T2 may be set by performing the effective pixel number measurement processing and the exposure time setting processing illustrated in FIG. 7 from the first image data I1.

### Summary of First Embodiment

As described above, according to the present first embodiment, first, the main controller 20 acquires the plurality of pieces of first image data I1 in which the imaging angle AG of the camera unit 41 with respect to the part 11 and the exposure time T1 for setting the brightness of the acquired image are different from each other. Subsequently, the number of effective pixels capable of generating a point group in each piece of the first image data I1 is calculated from the plurality of pieces of first image data I1, and the exposure time T2 in a case where the second image data I2 is captured by the camera unit 41 is determined and set on the basis of the number of effective pixels calculated. That is, the exposure time T2 is set on the basis of the plurality of pieces of first image data I1 captured while comprehensively changing the imaging angle AG and the exposure time T1 with respect to the part 11. As a result, in a case where the second image data I2 is imaged and acquired, the point group can be accurately generated regardless of the posture of the part 11. Therefore, for example, in the operation mode (picking work), the accuracy of the matching processing can be improved, and for example, the occurrence of errors such as the holding unit 32 interfering with the part 11 or the part 11 not being able to be held can be reduced.

In addition, even if samples in a state where the parts 11 are stacked in bulk are manually used as samples for setting the exposure time T2, the exposure time T2 can be set without being affected by the variation. That is, by comprehensively changing and imaging the imaging angle AG and the exposure time T1, image data of an imaging angle and an exposure time that are small or not obtained hitherto as samples among the parts 11 in a state of being stacked in bulk is not generated. Therefore, even in the case of using the parts 11 stacked in bulk as a sample, the influence of variation in the bulk stacking work of the parts 11 by hand does not occur, and the bulk operation can be shortened.

In a case where the exposure time T2 is set, a sum of the number of effective pixels calculated from the plurality of pieces of first image data I1 having the imaging angles AG different from each other is calculated for each exposure time T1, and the exposure time at which the sum becomes maximum is set as the exposure time T2. As a result, the exposure time T2 with the largest number of effective pixels can be set regardless of the imaging angle AG in the case of imaging the second image data I2.

Note that, in the present embodiment, the exposure time T2 has been described to be set from the sum of the number of effective pixels, but the present technology is not limited thereto, and the exposure time T2 may be set as long as a predetermined condition is satisfied. The predetermined condition in this case is desirably a condition under which the part 11 can be matched at any angle in an operation mode (picking work), for example. In particular, the predetermined condition is preferably a condition under which the part 11 can be held by the holding unit 32 and matching of the part 11 can be performed with accuracy that does not interfere with other parts 11. In other words, since the recognition accuracy of the required position and posture changes depending on, for example, the size and shape of the part 11 and the size and shape of the holding unit 32, it is preferable that the predetermined condition is determined so that the accuracy is satisfied.

Further, in the present embodiment, the main controller 20 displays a graph indicating the relationship between the number of effective pixels calculated from the plurality of pieces of first image data I1 having the imaging angles AG different from each other and the exposure time T1, and the exposure time T2 which is set, on the operation panel 21. As a result, the user can confirm the exposure time T2 set by the main controller 20. In addition, since the user can manually change the exposure time T2, the exposure time T2 set by the main controller 20 can be corrected to the exposure time T2 set by the user.

### Second Embodiment

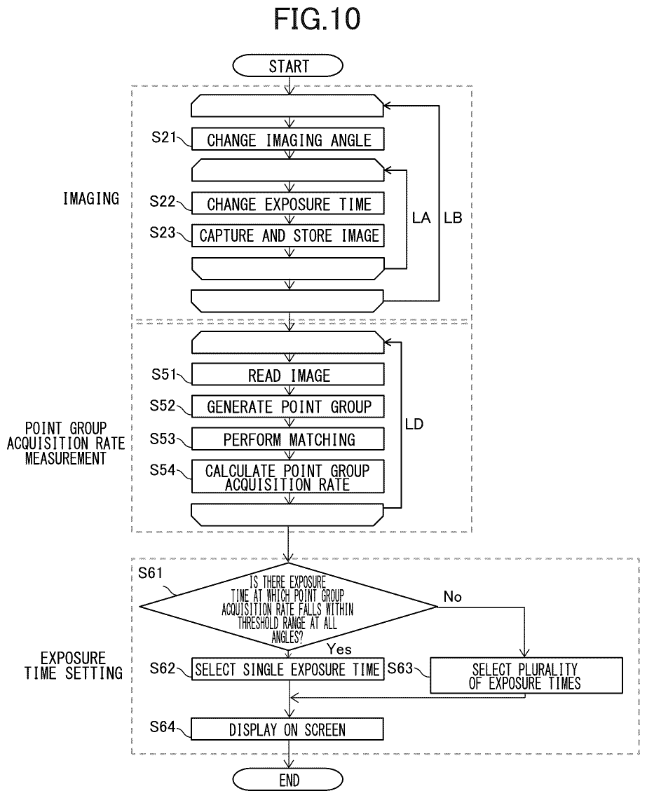

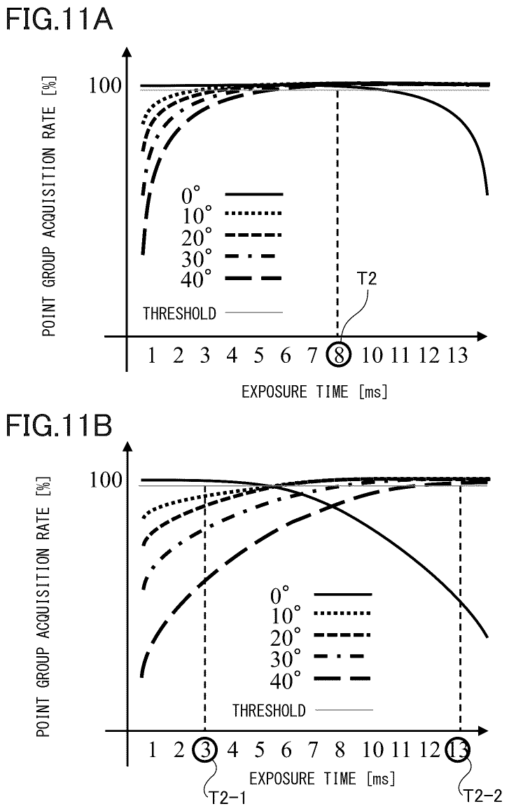

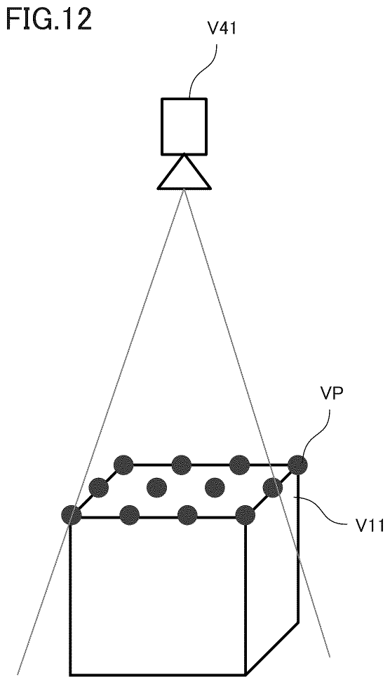

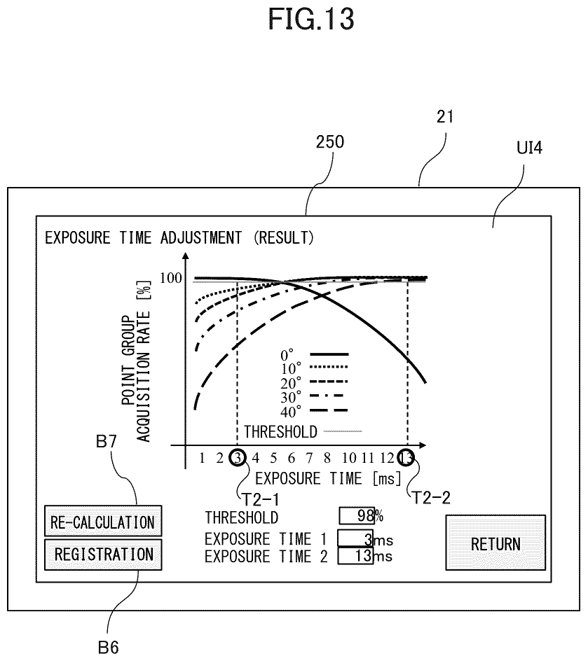

Next, a second embodiment partially modified from the first embodiment will be described with reference to FIGS. 10 to 13. FIG. 10 is a flowchart illustrating exposure time setting control in a setting mode according to the second embodiment. FIG. 11A is a diagram illustrating a case where a single exposure time is selected in the relationship between the point group acquisition rate of each angle measured by the measurement of the point group acquisition rate according to the second embodiment and the exposure time. FIG. 11B is a diagram illustrating a case where a plurality of exposure times are selected in the relationship between the point group acquisition rate of each angle measured by the measurement of the point group acquisition rate according to the second embodiment and the exposure time. FIG. 12 is an explanatory diagram illustrating a relationship among a virtual camera, a virtual workpiece model, and a virtual point group on a virtual space according to the second embodiment. FIG. 13 is an explanatory diagram illustrating an example of a display image of an exposure time adjustment result screen in a setting mode according to the second embodiment. In the description of the present second embodiment, the same reference numerals are used for the same parts as those of the first embodiment, and the description thereof will be omitted.

In the first embodiment described above, the number of effective pixels where the point group can be generated is measured from the plurality of pieces of first image data I1 having the different imaging angles AG and different exposure times T1, and the exposure time T2 is set on the basis of the number of effective pixels. On the other hand, in the present second embodiment, the point group is generated from the plurality of pieces of first image data I1, the point group is matched with the point group of the virtual model, the acquisition rate of the point group is calculated, and the exposure time T2 is set on the basis of the acquisition rate.

### Exposure Time Setting Control According to Second Embodiment

Next, exposure time setting control as a second setting process according to the second embodiment will be described. As illustrated in FIG. 10, the exposure time setting control according to the second embodiment is roughly divided into imaging processing, point group acquisition rate measurement processing, and exposure time setting processing, and is executed in this order. As in the first embodiment, the imaging processing is an image acquisition process of acquiring the plurality of pieces of first image data I1 in the main controller 20. In addition, the point group acquisition rate measurement processing is a rate calculation process of generating a point group from each piece of the first image data I1 acquired in the image acquisition process and calculating a rate of the number of points with respect to a point group that should be imaged in a case where an object is imaged by the camera unit 41 for the point group generated. Furthermore, the exposure time setting processing is a setting process of setting an imaging condition (exposure time T2) in a case where the second image data I2 is imaged by the camera unit 41 on the basis of the acquisition rate of the point group to be imaged which has been calculated in the point group acquisition rate measurement processing, that is, the size of the region calculated in the region calculation process.

In the present second embodiment, a description will be given of performing the point group acquisition rate measurement processing after the imaging processing is performed on all the first image data I1. However, the present technology is not limited thereto, and the point group acquisition rate measurement processing may be performed every time the imaging processing is performed for one image or a predetermined number of images, and then the process may return to the imaging processing for the other images.

As illustrated in FIG. 10, the imaging processing from step S21 to step S23 is similar to that of the first embodiment, and thus the description thereof will be omitted.

When the process proceeds to step S51 of the point group acquisition rate measurement processing, the CPU 401 of the image processing controller 40 reads the first image data I1 captured and stored in step S23. In step S51, the image is repeatedly processed by a loop LD, and the images in which the imaging angle AG and the exposure time T1 are changed are sequentially read each time. This loop LD is performed on all images captured by changing the imaging angle AG and the exposure time T1.

Subsequently, in step S52, the CPU 401 of the image processing controller 40 generates a point group for each of the first image data I1 read out in step S51, that is, generates a point group image of the first image data I1.

Next, in step S53, the CPU 401 of the image processing controller 40 matches the point group image of the first image data I1 generated in step S52 with the point group model or the contour model of the part 11 generated before. Then, the position and posture of the part 11 are estimated by the matching. Subsequently, in step S54, the CPU 401 of the image processing controller 40 calculates the ratio of the number of actually acquired points to the point group that should be imaged and generated by the camera unit 41 according to the position and posture of the part 11 estimated in step S53. That is, the point group acquisition rate is measured.

Here, the calculation of the point group acquisition rate will be specifically described. For example, when a part (workpiece) having a shape as illustrated in FIG. 12 is imaged from the camera unit 41 in the upward direction, only the upper surface can be imaged without capturing the side surface and the bottom surface. Therefore, assuming that the number of virtual point groups VP on the upper surface is 100% in a point group model V11 of the virtual part created before, the ratio of the number of point groups that can be acquired when the position and posture of the part 11 are matched with the point group model V11 is calculated. As a result, it can be seen how many point groups among the point groups of the part 11 that can be captured from the camera unit 41 can be acquired without missing.

In the determination of whether the point group is a point group that can be imaged and generated (that should be imaged and generated) from the camera unit 41 at a certain angle among the point groups included in the point group model V11, first, a virtual camera unit V41 and the point group model V11 are generated (arranged) in the position and posture estimated in the virtual space. When the camera unit V41 arranged in this manner is connected to a certain point of the point group model V11, it can be determined whether the connecting line intersects with the mesh constituting the surface the point group model V11. That is, in a case where the virtual line obtained by virtually extending the light beam from the virtual camera unit V41 to a certain point of the point group model V11 intersects only with the mesh including the point of the point group model V11, it is determined that the point is a point that can be imaged and generated (that should be imaged and generated) from the camera unit V41. On the other hand, in a case where the virtual line obtained by virtually extending the light beam from the virtual camera unit V41 to a certain point of the point group model V11 intersects with a mesh other than the mesh including the point of the point group model V11, it is determined that the point cannot be imaged and generated from the camera unit V41. Since the determination as to whether the point is a point that should be imaged in the virtual space as described above should be similar in the positional relationship between the actual part 11 and the camera unit 41, the point group that should be imaged and generated in the part 11 by the camera unit 41 is used. Note that the determination as to whether the point of the point group of the part 11 is a point that can be imaged and generated (that should be imaged and generated) by the camera unit 41 may be made using other methods.

When the calculation of the point group acquisition rate is completed for each piece of the first image data I1 in this manner, the process proceeds to step S61 of the exposure time setting processing. Then, the CPU 401 of the image processing controller 40 determines whether there is an exposure time during which the point group acquisition rate falls within a threshold range at all the imaging angles AG on the basis of the point group acquisition rate calculated in step S54.

Specifically, as illustrated in FIG. 11A, for example, in a case where the threshold of the point group acquisition rate is set to 98%, the point group acquisition rate exceeds the threshold at all angles in the range of the exposure time of 6 ms to 10 ms. Therefore, in a case where it is determined that there is an exposure time for which the point group acquisition rate falls within the threshold range at all angles (Yes in S61), the process proceeds to step S62.

On the other hand, for example, in a glossy part or the like, if the specular reflectance is high and the posture of the part is such that the imaging direction of the camera unit 41 is in the specular reflection direction with respect to the incident light from the illumination, the luminance value of the captured image is saturated, and the point group is likely to be missing. Furthermore, for example, in a part or the like that is less likely to be diffusely reflected, if the posture of the part is such that the imaging direction of the camera unit 41 is at an angle greatly different from the specular reflection direction with respect to the incident light from the illumination, the luminance value of the captured image is blackened, and the point group is likely to be missing. In such a case, as illustrated in FIG. 11B, for example, there is no exposure time during which the point group acquisition rate falls within the threshold range at all angles. In a case where it is determined to be no exposure time (No in S61), the process proceeds to step S63.

In a case where the process proceeds to step S62, the CPU 401 of the image processing controller 40 determines and selects the exposure time T2 in which the point group acquisition rate falls within the threshold range at all angles on the basis of the point group acquisition rate calculated in step S54 (that is, the exposure time T2 is set as the imaging condition). As illustrated in FIG. 11A, in a case where there are a plurality of candidates for the corresponding exposure time, the exposure time having the largest sum of numerical values of the point group acquisition rate for each angle may be selected as the exposure time T2, or the exposure time as the median value may be selected as the exposure time T2.

Then, the process proceeds to step S64, and the main controller 20 displays the graph illustrated in FIG. 11A (the point group acquisition rate calculated from the plurality of pieces of first image data I1 having the imaging angles different from each other) and the UI image indicating the selected exposure time T2 on the operation panel 21. Similarly, when a registration button of the UI image displayed on the operation panel 21 is pressed, the displayed exposure time T2 is overwritten as a setting value of the exposure time T2 in the operation mode. Similarly, by displaying a graph of the point group acquisition rate for each exposure time in the UI image, it is possible to confirm that the exposure time T2 has been normally adjusted. Furthermore, when the point group acquisition rate is extremely small depending on the imaging angle AG, the user can change the exposure time T2 by manually sliding the exposure time or directly inputting a value.

On the other hand, in a case where the process proceeds to step S63, the CPU 401 of the image processing controller 40 selects a plurality of exposure times T2−1 and T2−2 on the basis of the point group acquisition rate calculated in step S54 as illustrated in FIG. 11B. At this time, selection is made for the plurality of exposure times T2−1 and T2−2 such that the point group acquisition rates of all angles satisfy the threshold, that is, for the angle for which the point group acquisition rate does not satisfy the threshold at the exposure time T2−1, the point group acquisition rate is selected so as to satisfy the threshold at the exposure time T2−2. In other words, the angle at which the point group acquisition rate does not satisfy the threshold at the exposure time T2−2 is selected so that the point group acquisition rate satisfies the threshold at the exposure time T2−1. Specifically, the exposure time T2−1 as a first imaging condition is an exposure time in which the point group acquisition rate generated from the first image data I1 in which the imaging angle AG is within a first range (for example, 0 degrees to less than 10 degrees in FIG. 11B) is equal to or more than a threshold (for example, 98% or more). Furthermore, the exposure time T2−2 as a second imaging condition is an exposure time in which the point group acquisition rate generated from the first image data I1 in which the imaging angle AG is within a second range (from 10 degrees to 40 degrees in FIG. 11B) different from the first range is equal to or more than the threshold (for example, 98% or more).

As described above, for example, in the example of the point group acquisition rate illustrated in FIG. 11B, two exposure times are selected with 3 ms as the exposure time T2−1 and 13 ms as the exposure time T2−2. At the exposure time T2−1, the point group acquisition rate of the first image data I1 with the imaging angle AG as 0 degrees falls within the range of the threshold. At the exposure time T2−2, the point group acquisition rate of the first image data I1 with the imaging angle AG as 10 degrees to 40 degrees falls within the range of the threshold. As a result, all angles fall within the range of the threshold. As a method for selecting the exposure times T2−1 and T2−2, first, the range of the exposure time exceeding the threshold is obtained at each imaging angle AG, and one exposure time T2−2 is selected from the range of the exposure time exceeding the threshold at the most imaging angles AG. Next, at the exposure time T2−2, one exposure time T2−1 is selected from the range of the exposure time exceeding the threshold at the remaining imaging angles AG not exceeding the threshold.

In this way, for example, selecting two exposure times T2−1 and T2−2 means that two pieces of second image data I2 are acquired at different exposure times in the imaging of step S12 in the operation mode (picking work) (see FIG. 4). In this case, in step S13, the matching processing between the two pieces of second image data I2 and the model image is performed, that is, the matching processing is performed twice. Then, the posture of the part 11 is calculated from the two times of matching processing.

In the present second embodiment, the description has been made about two exposure times selected as described above, but the present technology is not limited thereto, and for example, three or more exposure times may be selected for a workpiece having different peaks of the point group acquisition rate for each imaging angle AG. In addition, in the operation mode (picking work), in a case where there is a margin in the measurement time (imaging, matching processing, and time for posture calculation) and it is desired to more reliably acquire the point group, a larger number of exposure times may be selected.

In addition, in the operation mode (picking work), the second image data I2 may be imaged at a plurality of exposure times which is set, a point group may be generated with each of the second image data I2, and the generated point group may be combined and used as a point group image of one second image data I2. Further, in the operation mode (picking work), an HDR synthesis processing may be performed on the plurality of pieces of second image data I2 captured at the plurality of exposure times, and the point group may be generated on the synthesized second image data I2. In other words, the exposure time T2−1 and the exposure time T2−2 are determined as the exposure time in a case where the second image data I2 is generated by the HDR synthesis. As a result, a plurality of times of matching processing is unnecessary in the matching processing of step S13, and the processing time can be shortened.

Then, when the selection (determination) of the plurality of exposure times T2−1 and T2−2 in step S63 is completed, the process proceeds to step S64. In step S64, the main controller 20 displays a UI image UI4 indicating the graph (the point group acquisition rate calculated from the plurality of pieces of first image data I1 having the imaging angles different from each other) illustrated in FIG. 11B and the selected exposure times T2−1 and T2−2 on the operation panel 21. When a registration button B6 of the UI image UI4 displayed on the operation panel 21 is pressed, the displayed exposure times T2−1 and T2−2 are overwritten as setting values of the exposure time T2 in the operation mode. Similarly, by displaying a graph of the point group acquisition rate for each exposure time in the UI image UI4, it is possible to confirm that the exposure times T2−1 and T2−2 have been normally adjusted. Furthermore, when the point group acquisition rate is extremely small depending on the imaging angle AG, the user can manually slide the exposure time or directly input the value, and can freely change the value or the number of the exposure times T2. In addition, the user can freely input the threshold value, and by pressing a recalculation button B7 after changing the threshold, the optimum exposure time T2 can be selected again according to the newly set threshold, and the selected exposure time T2 can be displayed as a graph.

Note that, as described above, after the exposure time setting control illustrated in FIG. 10 is executed and the setting of the exposure time T2 is completed, the parts 11 may be installed in a bulk state in the picking box 10 and imaged, and it may be confirmed whether the exposure time T2 which is set, is appropriate. At this time, the point group acquisition rate is calculated for each part 11 from among the parts 11 in a state of being stacked in bulk from the captured image, and is displayed on the operation panel 21. As a result, the user can confirm whether the point group acquisition rate is within the range of the threshold set by the user. Also in this case, the part 11 for calculating the point group acquisition rate is selected from the parts 11 on the surface layer in a state of being stacked in bulk by the user. This is because the part 11 under the overlap cannot be distinguished from the missing of the point group due to the exposure time because the point group cannot be acquired due to occlusion. Then, in a case where the point group acquisition rate does not fall within the range of the threshold set by the user, it is conceivable that the exposure time setting control is executed again or the user manually adjusts the exposure time T2. Furthermore, it is also conceivable to perform imaging while changing the exposure time T1 and the imaging angle AG with respect to the parts 11 in the current bulk state, and to re-acquire the plurality of pieces of first image data I1 obtained by imaging the parts 11 in the bulk state. That is, the exposure time T2 may be set by performing the point group acquisition rate measurement processing and the exposure time setting processing illustrated in FIG. 10 from the first image data I1.

### Summary of Second Embodiment

As described above, according to the present second embodiment, first, the main controller 20 acquires the plurality of pieces of first image data I1 in which the imaging angle AG of the camera unit 41 with respect to the part 11 and the exposure time T1 for setting the brightness of the acquired image are different from each other. Subsequently, the point group acquisition rate is calculated in each piece of the first image data I1 from the plurality of pieces of first image data I1, and the exposure time T2 in a case where the second image data I2 is captured by the camera unit 41 is set on the basis of the calculated point group acquisition rate. That is, the exposure time T2 is set on the basis of the plurality of pieces of first image data I1 captured while comprehensively changing the imaging angle AG and the exposure time T1 with respect to the part 11. As a result, in a case where the second image data I2 is imaged and acquired, the point group can be accurately generated regardless of the posture of the part 11. Therefore, for example, in the operation mode (picking work), the accuracy of the matching processing can be improved, and for example, the occurrence of errors such as the holding unit 32 interfering with the part 11 or the part 11 not being able to be held can be reduced.

In addition, even if samples in a state where the parts 11 are stacked in bulk are manually used as samples for setting the exposure time T2, the exposure time T2 can be set without being affected by the variation. That is, by comprehensively changing and imaging the imaging angle AG and the exposure time T1, image data of an imaging angle and an exposure time that are small or not obtained hitherto as samples among the parts 11 in a state of being stacked in bulk is not generated. Therefore, even in the case of using the parts 11 stacked in bulk as a sample, the influence of variation in the bulk stacking work of the parts 11 by hand does not occur, and the bulk operation can be shortened.

In addition, hitherto, in the method for setting the exposure time according to the number of point groups that can be acquired from the image obtained by imaging the parts 11 in a state where the parts are stacked in bulk, even if the missing of the point group occurs depending on the posture of the part 11, it is not known. However, by using the method for calculating the point group acquisition rate as in the present embodiment, it is possible to confirm whether the point group has been sufficiently acquired for each relative imaging angle AG between the part 11 and the camera unit 41.

In addition, it is determined whether the point group acquisition rates generated from the plurality of pieces of first image data I1 are equal to or greater than the threshold, and the exposure time in which it is determined that all of the point group acquisition rates are equal to or greater than the threshold is set as the exposure time T2 in a case where the second image data I2 is imaged by the camera unit 41. Thus, the optimum exposure time T2 can be set.

Furthermore, in a case where there is no exposure time for which it is determined that all of the point group acquisition rates are equal to or greater than the threshold, the plurality of exposure times T2−1 and T2−2 are determined as the exposure times in a case where the second image data I2 is captured by the camera unit 41. For example, the exposure time T2−1 is an exposure time in which the point group acquisition rate generated from the first image data I1 with the imaging angle AG within the first range is equal to or greater than the threshold. Furthermore, for example, the exposure time T2−2 is an exposure time in which the point group acquisition rate generated from the first image data I1 in which the imaging angle AG is within the second range different from the first range is equal to or greater than the threshold. That is, in the case of acquiring the second image data I2, hitherto, there is a case where a point group cannot be sufficiently acquired depending on the relative imaging angle AG between the part 11 and the camera unit 41. However, in this manner, by setting the plurality of exposure times T2−1 and T2−2 suitable for each posture (imaging angle AG) of the part 11 and acquiring the second image data by imaging at each exposure time, it is possible to reduce a missing point group or acquire all the point groups. Furthermore, by setting the plurality of exposure times in this manner, even if a camera having a small dynamic range is used as the camera used for the camera unit 41, missing of the point group can be reduced, and thus the camera unit 41 can be configured at low cost.

In addition, in a case where images are captured at the plurality of exposure times T2−1 and T2−2, the HDR synthesis processing is performed using the two pieces of second image data acquired by the imaging to generate second image data I2 synthesized. Then, by generating the point group for the combined second image data I2, the missing of the point group can be reduced, or the point group can be acquired without missing.

### Possibility of Other Embodiments

In the first and second embodiments described above, the exposure time is adjusted (set) as the imaging condition, but the present technology is not limited thereto, and a shutter speed, a diaphragm, brightness of illumination, and the like may be adjusted.

Furthermore, in the first and second embodiments described above, the stereo camera is used as the camera unit 41, but the present technology is not limited thereto, and any configuration may be used as long as it is an imaging unit capable of generating a point group from a captured image. For example, it may be configured by a two-dimensional camera and a distance sensor capable of measuring the distance to an object, and the surface shape may be acquired as a point group capable of expressing the height using a pattern of the illumination light or the like.

Furthermore, it has been described, in the exposure time setting control as the first setting process in the first embodiment, that the exposure time is set by measuring the number of effective pixels where the point group can be generated. It has been described, in the exposure time setting control as the second setting process in the second embodiment, that the exposure time is set by measuring the point group acquisition rate. However, only one of the exposure time setting controls may be executed, and both the exposure time setting controls may be executed selectively or in order to improve accuracy.

In the first embodiment, it has been described that one exposure time T2 is set from the sum of the number of effective pixels of each imaging angle AG in each exposure time T1. However, the present technology is not limited thereto, and whether the number of effective pixels satisfies the threshold may be set as in the second embodiment, and further, a plurality of exposure times may be set by dividing the range of the imaging angle in which the number of effective pixels satisfies the threshold. Furthermore, in a case where a plurality of exposure times are set in this manner, in the operation mode, a plurality of pieces of second image data I2 captured at the exposure times may be subjected to the HDR synthesis processing, and the matching processing may be performed using the synthesized image.

In the second embodiment, it has been described that whether a single exposure time can be selected is determined in step S61, and a plurality of exposure times are selected in a case where the single exposure time cannot be selected. However, the present technology is not limited thereto, and a plurality of exposure times may be selected from the beginning.

In the first and second embodiments, the second image data I2 has been described as the image data for capturing the part 11 when the operation mode (picking work) is executed, but the present technology is not limited thereto. That is, the image may be an image of any imaging timing and an image of any application as long as the image data is obtained in a case where the part 11 is imaged by the camera unit 41 to acquire a point group. As an example, for example, in a case where the position and posture of the part 11 conveyed by a belt conveyor or the like are measured by matching processing, it is conceivable to perform imaging at the exposure time T2 set as in the present embodiment, and the image data in such a case can be referred to as the second image data.

In the above-described embodiments, the case where the robot 30 is a vertically articulated robot arm has been described, but the present technology is not limited thereto. The robot 30 may be various robot arms such as a horizontal articulated robot arm, a parallel link robot arm, and an orthogonal robot. In addition, the present technology is also applicable to a machine capable of automatically performing an operation of expansion and contraction, bending and stretching, vertical movement, horizontal movement, or turning on the basis of information of a storage device provided in a control device, or a combined operation thereof.

The present technology is not limited to the embodiments described above, and many modifications can be made within the technical idea of the present technology. In addition, two or more of the above-described plurality of embodiments may be implemented in combination. In addition, the effects described in the embodiments merely enumerate the most suitable effects resulting from the present technology, and the effects according to the present technology are not limited to those described in the embodiments.

The present disclosure can also be realized by processing in which a program for realizing one or more functions of the above-described embodiments is supplied to a system or an apparatus via a network or a storage medium, and one or more processors in a computer of the system or the apparatus read and execute the program. The present technology can also be implemented by a circuit (for example, ASIC) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-200229, filed Nov. 27, 2023, which is hereby incorporated by reference herein in its entirety.

What is claimed is:

1. An information processing apparatus comprising:
a processor configured to
acquire a plurality of pieces of image data obtained by imaging an object by changing at least one of a relative positional relationship between the object and an imaging unit and an imaging condition of the imaging unit that sets a brightness of an image to be acquired,
acquire a region where a point group can be generated from each of the plurality of pieces of image data, and
set the imaging condition based on the regions acquired when the object is imaged by the imaging unit on a basis of the regions acquired.

2. The information processing apparatus according to claim 1, wherein
the imaging condition is an exposure time.

3. The information processing apparatus according to claim 1, wherein
the processor is configured to determine the imaging condition that satisfies a predetermined condition on a basis of the regions acquired, and sets the determined imaging condition as the imaging condition in a case where the object is imaged by the imaging unit.

4. The information processing apparatus according to claim 1, wherein
the processor is configured to acquire, for each of the imaging conditions, a sum of sizes of the regions acquired from the plurality of pieces of image data having the positional relationships different from each other, and set an imaging condition under which the sum is maximum, as the imaging condition in a case where the object is imaged by the imaging unit.

5. The information processing apparatus according to claim 1, wherein
the imaging unit is a stereo camera.

6. The information processing apparatus according to claim 1, wherein
the processor is configured to
acquire image data obtained by imaging the object under the imaging condition which is set, and
acquire information of a position of the object from the image data.

7. The information processing apparatus according to claim 1, wherein
the processor is configured to cause display, on a display device, of a graph indicating a relationship between sizes of the regions calculated from the plurality of pieces of image data having the positional relationships different from each other and the imaging conditions, and the imaging condition which is set.

8. The information processing apparatus according to claim 1, wherein
the processor is configured to execute a first setting process and a second setting process,
in the first setting process, the imaging condition is set when the object is imaged by the imaging unit based on sizes of the regions acquired, and
in the second setting process, the processor is configured to
generate the point groups from the plurality of pieces of image data, respectively,
calculate, for each of the generated point groups, a ratio of a number of points to a point group to be generated in a case where the object is imaged by the imaging unit in the same relationship as the positional relationship, and
execute setting of the imaging condition when the object is imaged by the imaging unit based on the ratios calculated.

9. An information processing apparatus comprising:
a processor configured to
acquire a plurality of pieces of image data obtained by imaging an object by changing at least one of a relative positional relationship between the object and an imaging unit and an imaging condition of the imaging unit that sets a brightness of an image to be acquired,
generate a point group from each of the plurality of pieces of image data,
calculate, for each of the point groups generated, a ratio of a number of points to a point group to be generated when the object is imaged by the imaging unit in the same relationship as the positional relationship, and
set the imaging condition when the object is imaged by the imaging unit based on the ratios calculated.

10. The information processing apparatus according to claim 9, wherein
a point group model of the object is generated in a virtual space, and
the point group to be generated is a point group that can be generated in the point group model in a case where the point group model is imaged by a virtual imaging unit arranged in the positional relationship.

11. The information processing apparatus according to claim 9, wherein
the imaging condition is an exposure time.

12. The information processing apparatus according to claim 9, wherein
the processor is configured to
determine, for each of the imaging conditions, whether each of the ratios of the point groups generated from the plurality of pieces of image data having the positional relationships different from each other is equal to or greater than a threshold, and
set an imaging condition under which it is determined that all of the ratios are equal to or greater than the threshold as the imaging condition when the object is imaged by the imaging unit.

13. The information processing apparatus according to claim 12, wherein
when there is no imaging condition under which it is determined that all of the ratios are equal to or greater than the threshold, the processor is configured to set a first imaging condition under which the ratio of a point group generated from image data in which the positional relationship is within a first range is equal to or greater than the threshold, and a second imaging condition under which the ratio of a point group generated from image data in which the positional relationship is within a second range different from the first range is equal to or greater than the threshold, as the imaging condition in a case where the object is imaged by the imaging unit.

14. The information processing apparatus according to claim 9, wherein
the processor is configured to
determine, for each of the imaging conditions, whether each of the ratios of the point groups generated from a plurality of pieces of image data having the positional relationships different from each other is equal to or greater than a threshold, and
set a first imaging condition under which the ratio of a point group generated from image data in which the positional relationship is within a first range is equal to or greater than the threshold, and a second imaging condition under which the ratio of a point group generated from image data in which the positional relationship is within a second range different from the first range is equal to or greater than the threshold, as the imaging condition in a case where the object is imaged by the imaging unit.

15. The information processing apparatus according to claim 13, wherein
the first imaging condition and the second imaging condition are set as imaging conditions in a case where image data when the object is imaged by the imaging unit is generated by HDR synthesis.

16. The information processing apparatus according to claim 9, wherein
the imaging unit is a stereo camera.

17. The information processing apparatus according to claim 9, wherein
the processor is configured to
acquire image data obtained by imaging the object under the imaging condition which is set, and
acquire information of a position of the object from the image data.

18. The information processing apparatus according to claim 9, wherein
the processor is configured to cause display, on a display device, of a relationship between the ratios of the point groups generated from the plurality of pieces of image data having the positional relationships different from each other and the imaging conditions, and the imaging condition which is set.

19. An information processing method for processing information by a processor, the method comprising:
acquiring, by the processor, a plurality of pieces of image data obtained by imaging an object by changing at least one of a relative positional relationship between the object and an imaging unit and an imaging condition of the imaging unit for setting brightness of an image to be acquired;
calculating, by the processor, a region where a point group can be generated from each of the plurality of pieces of image data; and
setting, by the processor, the imaging condition in a case where the object is imaged by the imaging unit on a basis of the regions calculated.

20. An information processing method for processing information by a processor, the method comprising:
acquiring, by the processor, a plurality of pieces of image data obtained by imaging an object by changing at least one of a relative positional relationship between the object and an imaging unit and an imaging condition of the imaging unit for setting brightness of an image to be acquired;
generating, by the processor, a point group from each of the plurality of pieces of image data, and calculating, for the generated point group, a ratio of a number of points to a point group to be generated in a case where the object is imaged by the imaging unit in the same relationship as the positional relationship; and
setting, by the processor, the imaging condition in a case where the object is imaged by the imaging unit on a basis of the ratios calculated.

21. A robot system comprising:
a robot;
an imaging unit; and
the information processing apparatus according to claim 1, wherein
the information processing apparatus controls the imaging unit on a basis of the imaging condition.

22. The robot system according to claim 21, wherein
the imaging unit is attached to the robot, and
the information processing apparatus changes the imaging condition by the robot when the imaging unit captures a plurality of pieces of image data.

23. The robot system according to claim 21, comprising
a holding unit that is attached to the robot and holds an object, wherein
the information processing apparatus is configured to execute
a first mode for setting the imaging condition, and
a second mode for acquiring image data by imaging the object by the imaging unit under the imaging condition set in the first mode, and holding the object by controlling the robot and the holding unit based on information regarding a position of the object acquired from the image data.

24. A method for controlling a robot system including a robot, an imaging unit, and the information processing apparatus according to claim 1, the method comprising
controlling the imaging unit, by the processor, on a basis of the imaging condition to perform imaging.

25. A method for manufacturing an article, wherein the article is manufactured using the robot system according to claim 23.

26. A non-transitory computer-readable recording medium having stored therein a program for causing a computer to execute the information processing method according to claim 19.

27. A non-transitory computer-readable recording medium having stored therein a program for causing a computer to execute the information processing method according to claim 20.
